(19) United States
(12) Patent Application Publication
(10) Pub. No.: US 2026/0110664 A1
(43) Pub. Date: Apr. 23, 2026

(54) Non-Volatile Threshold Sensing System Using Ferroelectric and Microacoustic Devices

(71) Applicant: Northeastern University, Boston, MA (US)

(72) Inventors: Cristian CASSELLA, Boston, MA (US); Onurcan KAYA, Boston, MA (US); Benyamin DAVAJI, Boston, MA (US); Luca COLOMBO, Boston, MA (US)

(21) Appl. No.: 19/111,491

(22) PCT Filed: Oct. 26, 2023
(86) PCT No.: PCT/US2023/036063

§ 371 Date: Mar. 13, 2025

Related U.S. Application Data
(60) Provisional application No. 63/419,382, filed on Oct. 26, 2022.

(51) Int. Cl. G01N 29/12; G01K 3/00; G01K 11/26; G01N 29/24

(52) U.S. Cl. CPC G01N 29/12; G01K 3/005; G01K 11/265; G01N 29/2462; G01N 2291/014; G01N 2291/023

(57) ABSTRACT

The present technology provides a threshold sensing device including an inductor, a ferroelectric varactor, and a resonator sensitive to a selected parameter of interest. The unbiased varactor has a memory window that grows proportionally with the partial switching of the varactor's ferroelectric domains. A DC voltage is generated across the varactor which, above a parameter threshold sensed by the resonator, drives the ferroelectric switching of the varactor. A nonvolatile shift in a radio frequency readout signal serves as a memory of an exceeded parameter threshold detected by the resonator. The sensor device can be used to detect temperature violations in a cold chain or the presence of a chemical or biological agent and is capable of battery-less operation.

### STATEMENT REGARDING FEDERALLY SPONSORED RESEARCH OR DEVELOPMENT

This invention was made with government support under Grant Numbers 2103351 and 2103091 awarded by the National Science Foundation. The government has certain rights in the invention.

### BACKGROUND

Improper refrigeration of food and drugs along the cold chain represents a huge problem, generating threats to human health, safety, and unsustainable economic losses. Fueled by the Radio-Frequency-Identification (RFID) revolution, several temperature sensing technologies have been developed, aiming at timely identifying and permanently marking any items undergoing temperature violations. [41-42] In this regard, thanks to their superior electromechanical performance and high Temperature-Coefficient-of-Frequency (TCF), various resonant microacoustic temperature sensors have been reported. Such devices can sense their ambient temperature with high-sensitivity, yet they cannot be used for threshold sensing. Also, they cannot keep track of any previously occurred temperature violations.

Achieving sensing systems that can sense a parameter of interest with high sensitivity and can memorize the occurrence of a certain threshold is currently impossible without requiring on integrated circuits, including comparators and memory devices as EEPROM. Yet, having heterogeneous components to exploit a threshold sensing functionality with memory capabilities does not represent a technically feasible solution, especially when targeting distributing sensing networks like those required to address the needs of emerging IoT applications.

### SUMMARY

The present technology provides a threshold sensing device including an inductor, a varactor, and a resonator sensitive to a selected parameter of interest. The varactor can be a ferroelectric varactor, such as a hafnium zirconium oxide (HZO) varactor, and the resonator can be a microacoustic resonator, such as a lithium niobate (LiNbO₃) MEMS resonator. The unbiased HZO varactor has a memory window that grows proportionally with the partial switching of the varactor's ferroelectric domains. A DC voltage is generated across the varactor which, above a parameter threshold sensed by the resonator, drives the ferroelectric switching of the varactor. A nonvolatile shift in a radio frequency (RF) readout signal serves as a memory of an exceeded parameter threshold detected by the resonator. A temperature threshold sensor embodiment was tested and yielded a 0.55 MHz non-volatile change in readout signal frequency in the event of exceeding a temperature threshold. The in-house fabricated LiNbO₃ resonator had a resonance frequency of 33.3 MHz for its SH0 mode with a quality factor of 1572 and kₜ² of 2%. The temperature or other parameter threshold can be tuned by changing the input resonance frequency. The sensor can be functionalized to detect threshold variations for other factors, such as the presence of a biological or chemical agent, and can be operated without requiring any onboard batteries, thereby supporting use in passive wireless sensor tags.

One aspect of the present technology is a parameter threshold sensor device. The device includes a circuit that has the following components arranged in series in the following order: a drive port, a resonator, a ferroelectric varactor, an inductor, and a read port. The inductor forms a series LC resonant circuit with the varactor. The LC resonant circuit is in series with the resonator. The inductor is connected to the read port and the resonator is connected to the drive port. When a continuous wave signal is applied at the drive port, at a frequency close to but slightly detuned from the resonance frequency of the resonator, detection of a threshold violation of the parameter of interest is associated with a non-volatile change in capacitance of the varactor and a shift in its resonance frequency detectable at the read port.

Another aspect of the technology is a parameter threshold sensor system. The system includes the sensor device described above, a wireless receiver or electromagnetic radiation harvesting module connected to the drive port of the sensor device, and a wireless transceiver connected to the read port of the sensor device. The drive port receiver or electromagnetic radiation harvesting module is configured for providing a source signal at the drive port. The read port transceiver is configured to receive a frequency sweep signal from a remote reader device and for transmitting data or a signal that allow the resonance frequency at the read port of the sensor device to be read by the remote reader device. The system can also include the reader device, which is enclosed in a separate portable housing.

Yet another aspect of the technology is a method of detecting a parameter threshold variation. The method includes the steps of: (a) providing the parameter threshold sensor device described above disposed on an article or in an environment; (b) applying a continuous wave signal at the drive port of the device; (c) applying a sweep of frequency at the read port of the sensor device using a remote reader device and receiving an output signal across the sweep of frequency using the remote reader device; and (d) determining whether a threshold deviation of said parameter has occurred. In step (b), the applied signal has a frequency that is slightly detuned from the resonance frequency of the resonator. In step (c), a readout resonance frequency at the read port of the device is determined, which is referable to the resonance frequency of the inductor+varactor (LC) resonance. In step (d), the determined readout resonance frequency is compared to an expected readout resonance frequency for a sub-threshold range of said parameter, and an observed deviation from the expected readout resonance frequency can indicate a parameter threshold violation.

The present technology can be further summarized with the following listing of features.

1. A parameter threshold sensor device comprising, in series, a drive port, a resonator, a ferroelectric varactor, an inductor, and a read port;
wherein the inductor forms a series LC resonant circuit with the varactor;
wherein the LC resonant circuit is in series with the resonator;
wherein the inductor is connected to the read port and the resonator is connected to the drive port; and
wherein, with application of a continuous wave signal at the drive port at a frequency detuned from a resonance frequency of the resonator, detection of said parameter by the device in an amount above a preset threshold causes a non-volatile change in capacitance of the varactor and a shift in resonance frequency detectable at the read port.
   2. The sensor device of feature 1, wherein the resonator is a surface acoustic wave resonator.
   3 The sensor device of feature 2, wherein the surface acoustic wave resonator comprises a piezoelectric material selected from the group consisting of LiNbO₃, AlN, and AlScN.
   4. The sensor device of any of the preceding features, wherein the ferroelectric varactor comprises a ferroelectric material selected from the group consisting of hafnium zirconium oxide (Hf_{0.5}Zr_{0.5}O₂), scandium-doped aluminum nitride (AlScN), lead zirconium titanate (PZT), barium titanate (BiTiO₃), or barium strontium titanate (BST).
   5. The sensor device of any of the preceding features, further comprising one or more additional serially linked resonator-varactor pairs, wherein each serially linked resonator-varactor pair is sensitive to detecting a threshold of a different parameter or a different threshold of a common parameter.
   6. The sensor device of any of the preceding features, wherein the preset threshold is determined by the resonance frequency of the resonator.
   7. The sensor device of any of the preceding features, wherein the capacitance of the varactor is altered by a change in said parameter.
   8. The sensor device of any of the preceding features, wherein said parameter is temperature or pressure.
   9. The sensor device of any of the preceding features, wherein said parameter is the presence, absence, or amount of a biological or chemical agent.
   10. The sensor device of feature 9, wherein the resonance frequency detectable at the read port is altered by binding of the biological or chemical agent to a receptor for the biological or chemical agent, and wherein the receptor is bound to the varactor or to a vibrating element of the resonator.
   11. The sensor device of any of the previous features, wherein the device does not comprise a battery.
   12. The sensor device of any of the previous features, wherein the device does not comprise a semiconductor memory.
   13. The sensor device of any of features 1-10, wherein the device comprises a battery and a semiconductor memory.
   14. A parameter threshold sensor system comprising:
(i) the sensor device of any of the preceding features;
(ii) a wireless receiver connected to the drive port of the sensor device, wherein the receiver is configured for providing a source signal at the drive port; and
(iii) a wireless transmitter connected to the read port of the sensor device, the receiver configured for transmitting the resonance frequency at the read port of the sensor device to a remote reader device.
   15. The system of feature 14, further comprising a readout transceiver for use as the remote reader device.
   16. A method of detecting a parameter threshold variation, the method comprising the steps of:
(a) placing the parameter threshold sensor device of any of features 1-13 on an article or in an environment;
(b) applying a continuous wave signal at the drive port of the device, wherein the signal has a frequency detuned from the resonance frequency of the resonator of the device;
(c) applying a sweep of frequencies at the read port of the sensor device using a remote reader device and receiving an output signal across the sweep of frequencies using the remote reader device, thereby determining a readout resonance frequency at the read port of the device; and
(d) comparing the determined readout resonance frequency to an expected readout resonance frequency for a sub-threshold range of said parameter, thereby determining whether a threshold deviation of said parameter has occurred.
   17. The method of feature 16, wherein step (d) comprises comparing the output signal at two or more selected wavelengths to expected values of an output signal at said two or more selected wavelengths characteristic of a sub-threshold range of said parameter.
   18. The method of feature 16 or feature 17, wherein the parameter is temperature, pressure, or the presence, absence, or amount of a biological or chemical agent.

### BRIEF DESCRIPTION OF DRAWINGS

FIG. 1A shows a schematic illustration of a parameter threshold sensor device of the present technology. FIG. 1B shows a schematic illustration of a system for testing the device shown in FIG. 1A.

FIG. 2A shows an illustration of the key steps in fabricating a microacoustic lithium niobate resonator for use in the sensor device of the present technology. FIG. 2B shows a scanning electron micrograph of an array of the lithium niobate resonators. FIG. 2C shows a Finite Element Model (FEM) simulation result of a single resonator structure of the type shown in FIG. 2B. FIG. 2D shows measured and mBVD fitted admittance response of the LiNbO₃ resonator array of FIG. 2B.

FIG. 3A shows a 3D drawing and simplified cross-section of an HZO varactor used in an exemplified parameter threshold sensor device of the present technology. FIG. 3B shows a cross-sectional illustration of key structures formed during fabrication of the HZO varactor. FIG. 3C shows an SEM image of the fabricated HZO varactor.

FIGS. 4A-4D illustrate the operation of an embodiment of a temperature threshold sensor.

FIG. 5A shows a schematic of the circuit simulation used for estimating the generated voltage across the HZO varactor (V_{DC}) and the threshold temperature of the sensing system (Tₐ). The fitted capacitance (C_{HZO}) and equivalent parallel resistance (R_{HZO}) responses of the HZO varactor to an applied external bias voltage (V_{DC}) are shown in FIGS. 5B and 5C, respectively.

FIG. 6A shows the reflection coefficient (S₁₁) at the circuit's drive port, and FIG. 6B shows the voltage generated across the HZO varactor (V_{DC}) for several fᵢₙ values with an input power of 10 dBm when ambient temperature (Tₐ) is swept from 25° C. to 125° C. The results show that S₁₁ reaches a minimum and V_{HZO} a maximum for a specific Tₐ value (Tₜₕ).

In FIG. 7, the change in Δf_{read} under external bias voltage shows an asymmetric response to negative and positive bias voltage levels, resulting a 1.7 MHz memory window when the HZO varactor is unbiased.

FIG. 8 shows the response of the threshold sensor when a continuous wave RF frequency (fᵢₙ) was swept from 33.1 MHz to 33.64 MHz in both forward and backward directions.

FIG. 9 shows the input admittance of the sensor relative to the drive port at different temperatures.

FIG. 10 the temperature response of a printed circuit board with off-the-shelf components.

FIGS. 11A and 11B show the applied temperature profile and the resulting change in Δf_{read} for fᵢₙ=33.278 MHz when RF power was ON and OFF. The highlighted region indicates clear evidence of ferroelectric switching, characterized by a positive slope in Δf_{read} during switching and a constant value otherwise. FIGS. 11C and 11D show the temperature profile and the resulting change in Δf_{read} for fᵢₙ=33.200 MHZ, comparing cases where the threshold temperature is exceeded and not exceeded. These results are superimposed with the previous experiments for comparison. Similar to previous observations, a positive slope for Δf_{read} was observed only when the threshold temperature was exceeded.

FIG. 12A shows the measured capacitance (C_{HZO}) and tanδ (δ_{HZO}) of the HZO varactor when the voltage across the varactor (V_{DC}) was swept from 0 V to 6 V (line segment A), from −6 V to 6 V (line segment B) and from −6 V to 0 V (line segment C). FIG. 12B shows the change of memory window for varying maximum DC voltage values (V_{DC}^{(max)} extracted by measuring the small signal capacitance of the negatively polarized HZO varactor by sweeping the V_{DC} up to the corresponding V_{DC}^{(max)} value and then back to 0 V. FIG. 12C shows three example small signal capacitance measurements of the HZO varactor used to extract the memory window.

### DETAILED DESCRIPTION

The present technology provides a novel threshold sensor device and system able to detect and memorize the occurrence of parameter violations, such as temperature range violations, by using a simple circuit containing a resonator, a ferroelectric varactor, and an inductor.

The sensor device can memorize the occurrence of violations in a targeted parameter of interest, potentially without requiring any DC-bias. The device can be programmed to change the parameter threshold, and can be reset to be used multiple times. The sensor device can augment the capabilities of other microelectromechanical sensors by making them able to detect violations in the sensed parameter of interest. The resonator of the device can be made sensitive to a wide variety of biomolecules and chemical compounds, thus enabling the device to be used for sensing of biological and chemical agents. The sensor device can be used in sensor tags to memorize the occurrence of temperature violations, such as in cold-chain applications. The measured information is stored on the ferroelectric varactor, and therefore any closed-loop resonant system, like those used for RFID tags, can be used for sensing and read-out.

The sensor device can be excited by a continuous-wave signal applied to a drive port with frequency (fᵢₙ) close to the resonator's resonance frequency. The inductor forms a series LC resonant circuit with the varactor, whose resonance frequency (f_{read} ), measured at a read port, is used as the readout parameter. The resonator is sensitive to a monitored environmental parameter, such as temperature, pressure, or the presence of a chemical or biological agent. Many resonators are intrinsically sensitive to temperature or pressure and can be used for this purpose without modification. Resonators also can be made sensitive to specific biomolecules or chemical compounds by known methods, for example by adding an aptamer, receptor, or antibody to the resonator to alter its resonance frequency upon binding of the target molecule.

When the parameter changes, the resonator's resonance frequency shifts, triggering a passive amplification of the varactor's voltage at fᵢₙ that induces a ferroelectric switching in the varactor. The sensor device thus can be used to detect when the parameter's value exceeds a preset threshold, which is set by the selected fᵢₙ-value. As a result, f_{read} undergoes a non-volatile change when the parameter threshold is exceeded, allowing the occurrence of the threshold violation to be captured and memorized. The sensor device can operate without the need for a battery or a semiconductor memory.

Threshold deviation detection relies on a change in capacitance of the varactor, which drives ferroelectric switching of the varactor. Therefore, the varactor must be a ferroelectric varactor, and it is preferable that the varactor have a low coercive voltage, to minimize the voltage needed to program the threshold detection memory of the device. The coercive voltage is the minimum voltage the varactor needs to completely change its ferroelectric polarization from positive to negative.

An example of the sensor device was constructed using a lithium niobate (LiNbO₃) shear-horizontal (SH) Lamb wave microacoustic resonator, whose inherent temperature sensitivity allowed it to be used as a temperature sensing element. However, any type of resonator can be used in the sensor, such as a ceramic resonator, a surface acoustic wave resonator, a dielectric resonator, a crystal resonator, a coaxial resonator, or a yttrium iron garnet resonator. The fabricated device also contained a 20 nm thick hafnium zirconium oxide (HZO, Hf_{0.5}Zr_{0.5}O₂) ferroelectric varactor, and an inductor. The sensor device was driven by a continuous-wave signal at a frequency slightly detuned from the resonance frequency of the LiNbO₃ resonator (fᵣₑₛ˜33 MHz). When the ambient temperature changed, the voltage at 33 MHz across the varactor increased proportionally to the resonator's figure-of-merit (FoM), ultimately causing a ferroelectric switch of the HZO varactor for a temperature exceeding a certain programmable threshold (Tₜₕ). Following such a switch, the capacitance of the HZO varactor (CT) experienced a sudden change, causing a non-volatile 0.75 to 1 MHz shift of the readout resonance frequency (f_{read}˜260 MHz). The ability to generate temperature-induced non-volatile changes of f_{read} through HZO ferroelectric varactors and microacoustic resonators can be implemented as a threshold-sensing functionality, and used to memorize the occurrence of any temperature threshold violations.

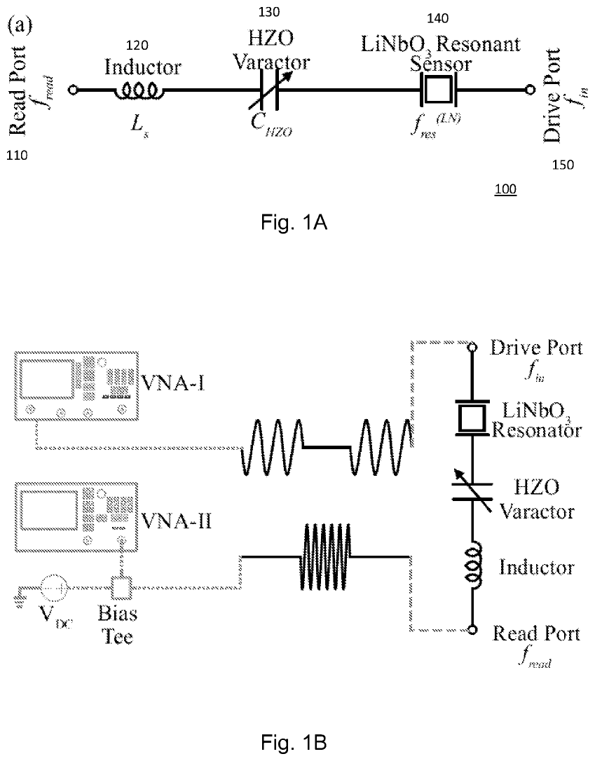

Turning now to FIG. 1A, parameter threshold sensor device 100 includes three components in series: inductor 120, varactor 130, and resonant sensor element 140. Drive port 150 is coupled to one side of the resonator, and read port 110 is coupled to the inductor. Each of the ports can be connected to further circuitry, such as a wireless receiver or transceiver with an antenna, as required for the application. The sensor device circuit can be implemented using any suitable available technology, including on a chip fabricated by a CMOS process or on a printed circuit board (PCB). Multiple devices can be integrated on the same chip for mass-scale fabrication. The devices can be built with a 4-mask fabrication process, thus without requiring a full CMOS-process.

In use the sensor device operates within a system that also includes a signal source connected to the drive port and a readout device in communication with the read port. Such a system was simulated as shown in FIG. 1B. A first vector network analyzer (VNA-I) provided the source signal at the drive port, and a second (VNA-II) provided the sweep signal at the read port. A DC power supply was added to the VNA-II signal via a bias tee. This setup was used to characterize the system operation of the sensor device.

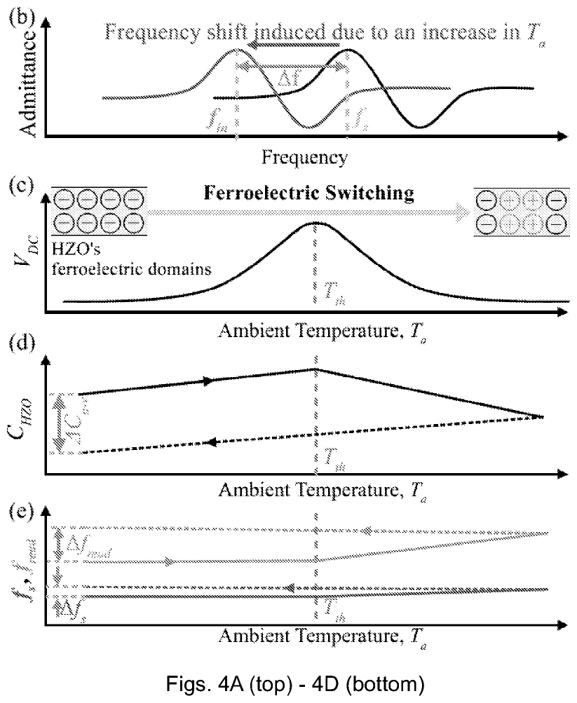

The principle of operation of a temperature threshold sensor is illustrated in FIGS. 4A-4D. In FIG. 4A the resonator is excited by a continuous-wave signal with a frequency (fᵢₙ) that is detuned by Δf from the resonance frequency (fₛ) of the series of the LiNbO₃ sensor with the HZO varactor. When the ambient temperature (Tₐ) increases, the resonance frequency of the resonator shifts left, decreasing the Δf between fᵢₙ and fₛ. In FIG. 4B the decrease in Δf generates a passive voltage amplification at fᵢₙ across the varactor, which in turn produces a DC voltage across the varactor (V_{DC}) due to the HZO varactor's inherit nonlinear response, triggering ferroelectric switching. In FIG. 4C, this leads to a non-volatile change in the varactor's capacitance value (ΔCₙ₋ᵥ). FIG. 4D shows that the non-volatile change in capacitance pulls both fₛ and the resonance frequency of the LC-readout circuitry (f_{read}). The change in f_{read} is more easily recognizable compared to the change in fₛ.

### EXAMPLES

### Example 1. Fabrication of a Lithium Niobate Microacoustic Resonator

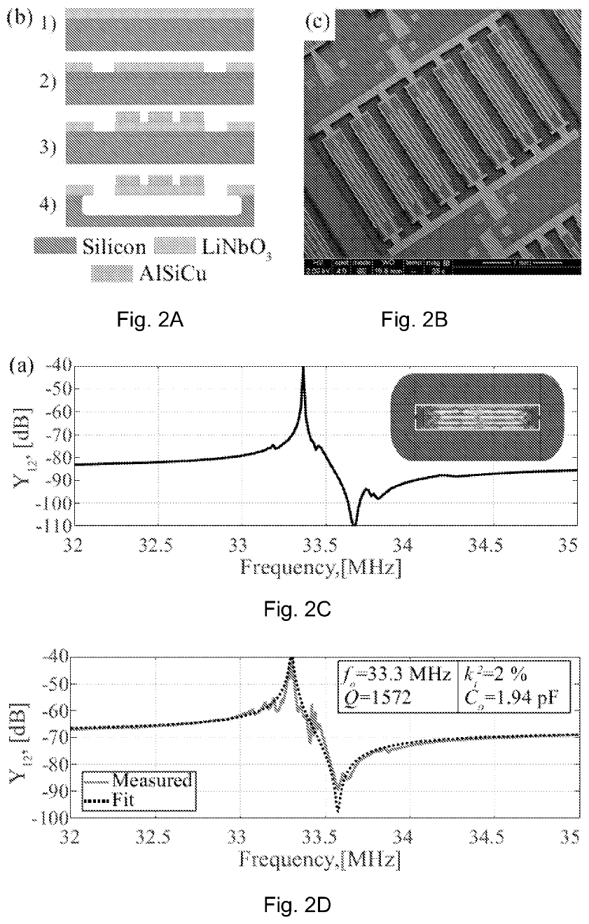

A LiNbO₃ microacoustic resonator was designed, built, and tested; it contained an array of seven identical resonators operating at 33.3 MHz. Each resonator contained an interdigitated electrode (IDT) with a pitch of 57 μm, deposited on top of a suspended 2.5 μm-thick LiNbO₃ X-cut film. The fabrication scheme of the LiNbO₃ resonator is represented in FIG. 2A, and an SEM image of the resonator device is shown in FIG. 2B. The finite element modeling simulation result of a single resonator is given in FIG. 2C. The device exploits the shear horizontal (SH0) mode, which is excited in the YZ30° direction for quality factor maximization at a lower frequency compared to the S0 mode.

A 500 μm X-cut LiNbO₃ thin film was bonded on a high-resistivity silicon wafer through surface activated bonding. Then, the LiNbO₃ film was thinned down to its desired thickness of 2.5 μm. An ion milling step was performed to form the release windows. Then, a 400 nm-thick AlSiCu layer was sputtered and patterned via lift-off to form the resonator's top electrodes. Finally, the device was released through a XeF₂ isotropic etch. Electrical characterization of the device was performed, and its measured admittance is shown in FIG. 2D, together with its mBVD fitting parameters.

### Example 2. Fabrication of an HZO Ferroelectric Varactor

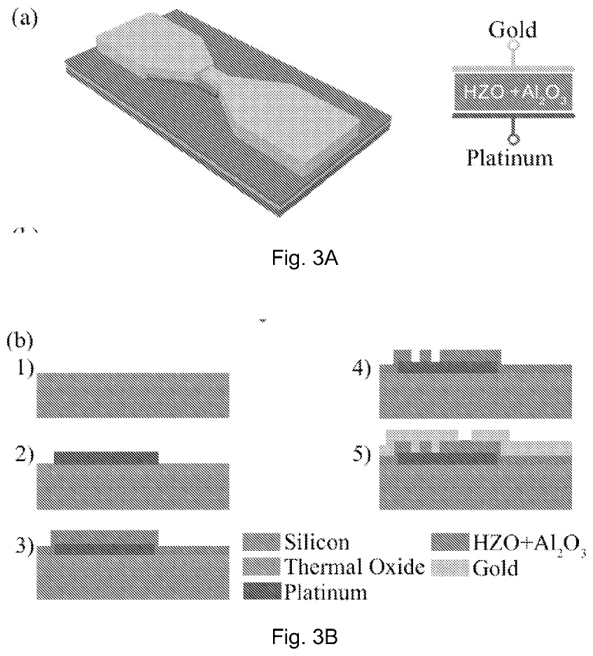

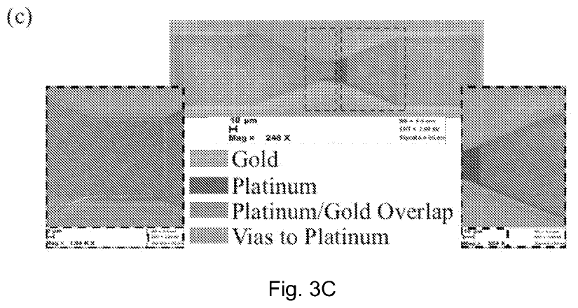

The HZO varactor possessed a rectangular-shaped parallel plate capacitor formed by a 20 nm-thick HZO film sandwiched between two metal layers (see FIG. 3A). The varactor was fabricated using the process shown in FIG. 3B. The fabrication started from a low resistivity silicon wafer covered by a 150 nm thick layer of thermal oxide. The bottom electrodes were formed by patterning a sputtered 100 nm-thick platinum layer through a lift-off step. A bilayer lift-off process was optimized to prevent fencings along the bottom electrode's edges. Then, atomic layer deposition was utilized to deposit a 20 nm thick HZO layer and a 3 nm thick Al₂O₃ capping layer. Tetrakis (dimethylamido) hafnium (TFMAHf) and tetrakis (dimethylamino) zirconium (TDMAZr) precursors were alternately used to form the HZO layer, followed by water pulses generating O₂. Then, the capping layer was deposited using alternating pulses of trimethylaluminium (TMA) and water precursors. Next, vias were etched by using a dry etching process. Subsequently, a 150 nm-thick gold layer was deposited using e-beam evaporation and patterned via lift-off in order to form the top electrode. Finally, the HZO varactor was annealed for 40 seconds at 400° C. using a rapid thermal processor operating under vacuum. A scanning electron microscope image of the fabricated HZO varactor is shown in FIG. 3C.

### Example 3. Characterization of HZO Ferroelectric Varactor

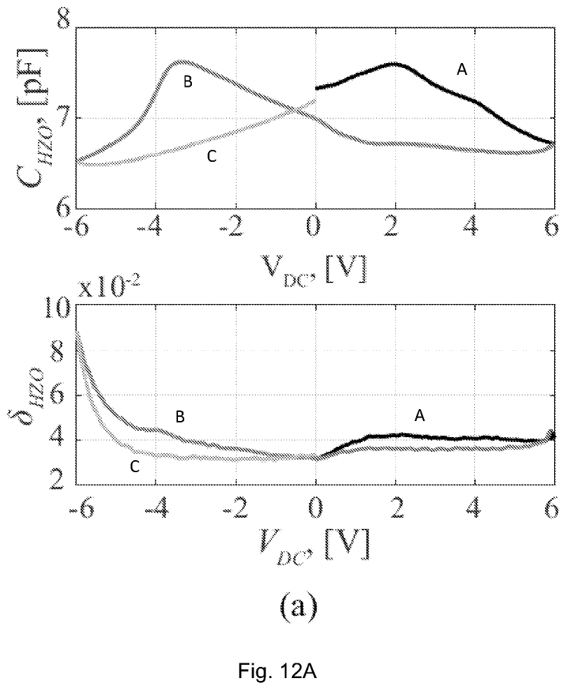

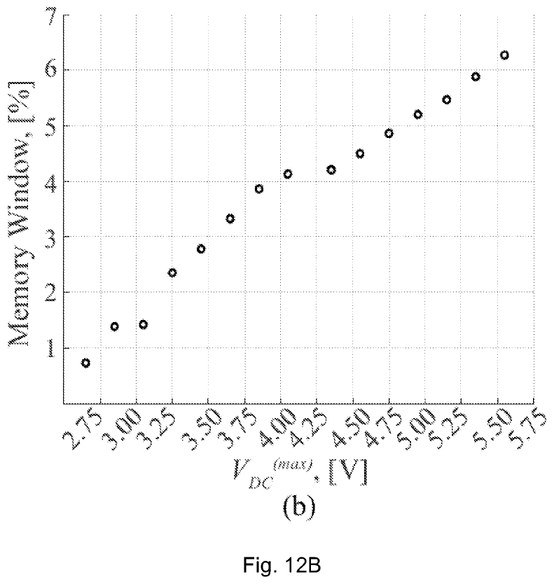

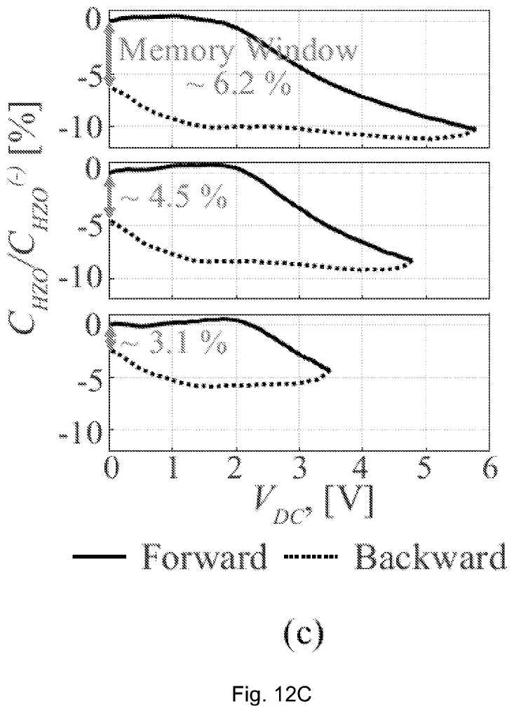

The threshold sensor relies on a change in varactor capacitance, ΔCn-v, due to a DC bias at the varactor, V_{DC}, generated by Gᵥ. However, knowing the non-volatile small signal capacitance behavior of the HZO varactor under pure DC signal is important to reveal the capabilities of the whole system. In this regard, reported in FIG. 12A are the measured C_{HZO} and loss tangent (δ_{HZO}) values when sweeping V_{DC} from 0 V to 6 V (line segment A), from 6 V to −6V (line segment B) and from −6 V to 0 (line segment C). These trends were extracted by sweeping an applied V_{DC} while simultaneously using a 5 kHz sinusoidal signal with a 100 mV peak value on an initially negatively polarized varactor [39]. From FIG. 12A the coercive voltages relative to the two polarization states (e.g., V_{c}⁺ and V_{c}⁻ ere found to be equal to +2 V and −3.8 V, respectively. Also, due to the asymmetry in the C_{HZO} and δ_{HZO} curves vs. V_{DC}, the generation of a non-nulled ΔCₙ₋ᵥ value ultimately leads to a non-zero ΔC_{n-w}/C_{HZO(-)} value at V_{DC}=0 V. Such a memory window value (ΔCₙ₋ᵥ/C_{HZO(-))} grows proportionally with the maximum applied V_{DC} value (V_{DC}^{(max)}). FIG. 12B shows the measured trend of the memory window vs. V_{DC}^{(max)}. This trend was found after running a reset-cycle before the extraction of C_{HZO} for each analyzed V_{DC} value. Such a reset cycle was aimed at negatively and fully polarizing the HZO varactor. Then, the small signal capacitance behavior of the HZO varactor was measured by sweeping V_{DC} in the forward direction up to the corresponding V_{DC}^{(max)} value and back to 0 V. It was found that the memory window exceeded 6% when V_{DC}^{(max)} was 5.8 V. To further show the dependence of the memory window on the V_{DC}^{(max)} value, FIG. 12C presents three sample measurements of C_{HZO}/C_{HZO(-)} vs. V_{DC} trends, which were used to extract the memory window when V_{DC} values were swept between 0 V and +3.4 V, +4.8 V, and +5.8 V. It is worth noting that the ability to produce and leverage C_{HZO}/C_{HZO(-)} values different from zero at zero-bias voltage enables the memory window that can be used to implement a passive and batteryless threshold sensing equipped with memory capabilities.

### Example 4. PCB Model of a Threshold Sensor Device

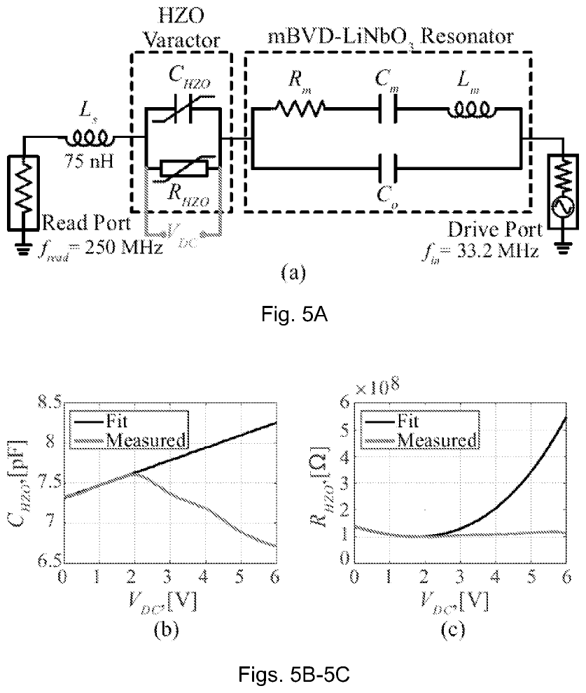

After completing the fabrication of both the HZO varactor and the LiNbO₃ microacoustic resonator devices, PCB hosting of a threshold sensing device was prepared. An inductor with an Ls value of 75 nH was selected, which ensured an f_{read} value of 260 MHz. Such a frequency was selected to make sure that a significant Δf_{read} value could be generated from the ferroelectric switch of the HZO varactor, while also minimizing the impact of the board's parasitics on the measured performance. An analysis of the expected system response was performed based on a set of circuit simulations (see FIG. 5A).

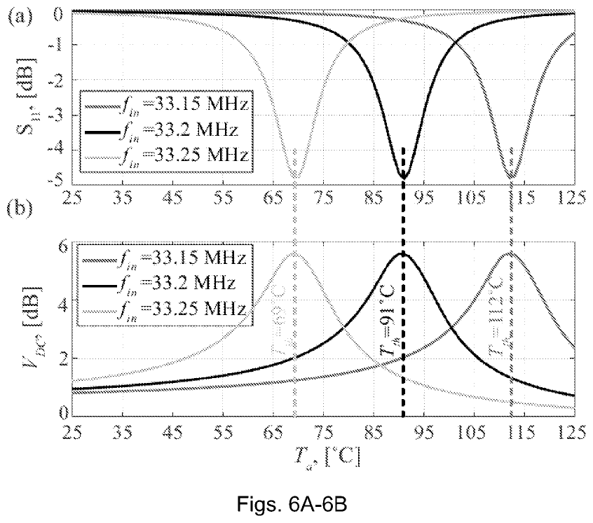

Commercial circuit simulators cannot capture the ferroelectric switching dynamics and the hysteresis behavior in the varactor's capacitance. Nonetheless, relying on harmonic balance in a commercial circuit simulator allows estimation of the DC voltage nonlinearly generated across the HZO varactor when the system is driven by a continuous wave signal with frequency fᵢₙ. Also, running harmonic balance circuit simulations allows estimation of the Tₐ value at which the highest V_{DC} is developed, producing the highest ΔCₙ₋ᵥ and Δf_{read} values. This can be done by taking into account the correlation between the f_{res(LN)} and Tₐ. This correlation is determined by the TCE of the LiNbO₃ film. The HZO varactor was assumed to be in its negative polarization state. In addition, symbolically defined nonlinear capacitor and resistor models were generated. These models capture the measured C_{HZO} and δ_{HZO} vs. V_{DC} of the HZO varactor (FIG. 12A) during its operation in the negative polarization state up to V_{c}⁺. Fitted responses of the C_{HZO} and equivalent parallel resistance (R_{HZO}) vs. the V_{DC} are given in FIGS. 5B and 5C. Also, a realistic quality factor value was used for the inductor, and a temperature-dependent mBVD model was employed based on mBVD fitted response in FIG. 2D to describe the LiNbO₃ sensor's admittance. Specifically, the sensor's resonance frequency was considered to vary with Tₐ, assuming a temperature coefficient of frequency (TC_{f})=124 ppm/° C. for the LiNbO₃ device based on measurements. Then, an input frequency of fᵢₙ=33.2 MHz was assumed, slightly lower than fₛ (33.35 MHz) and a fixed input power level of 10 dBm was used, matching the one used in experiments. Finally, Tₐ was swept from 25° C. to 125° C., extracting the reflection coefficient at the circuit's input (e.g., the s₁₁, see FIG. 6A) and V_{DC} (FIG. 6B) for every single analyzed temperature. Evidently, as the temperature increases, the S₁₁ lowers first, reaching its minimum value for the specific Tₐ value (Tₜₕ=91° C.) nulling Δf. In contrast, the S₁₁ increases proportionally with Tₐ for Tₐ>Tₜₕ. It is worth noting that when Tₐ is equal to Tₜₕ, Δf becomes equal to zero as fₛ matches fᵢₙ, leading to the maximum voltage at fᵢₙ across the HZO varactor and, consequently, to the maximum generated V_{DC} value. Comparing maximum V_{DC} values obtained in FIG. 6B with FIG. 12B reveals that Gᵥ can create a large enough V_{DC} to have a non-zero memory window. Finally, the same simulation was repeated for two more fᵢₙ values to illustrate the Tₜₕ tunability of the system. In this threshold sensing system, Tₜₕ is directly set by Δf as it needs to be nullified for the generation of the maximum V_{DC}. As can be seen from FIG. 6A-6B, for fᵢₙ=33.25 MHz (i.e., when fᵢₙ is closer to fₛ resulting in a 50 kHz smaller Δf), Tₜₕ decreases to 69° C. while Tₜₕ increases to 112° C. when fᵢₙ is set to 33.15 MHz.

### Example 5. Characterization of a Temperature Threshold Sensor Device

The experimental setup depicted in FIG. 1B was used for these experiments. VNA-I was responsible for exciting the resonator with a continuous wave (CW) signal with a frequency of fᵢₙ and recording the drive port's input impedance. VNA-II was used to measure f_{read} . A bias-tee and a DC-power supply were connected to VNA-II to reset the varactor and to measure its characteristics under different bias voltage levels. For temperature threshold sensing experiments, an LM35 temperature sensor was attached to the top of the PCB using thermally conductive double-sided tape. The sensor's analog voltage output was measured with an oscilloscope to monitor the PCB's temperature.

### Response to DC Voltage

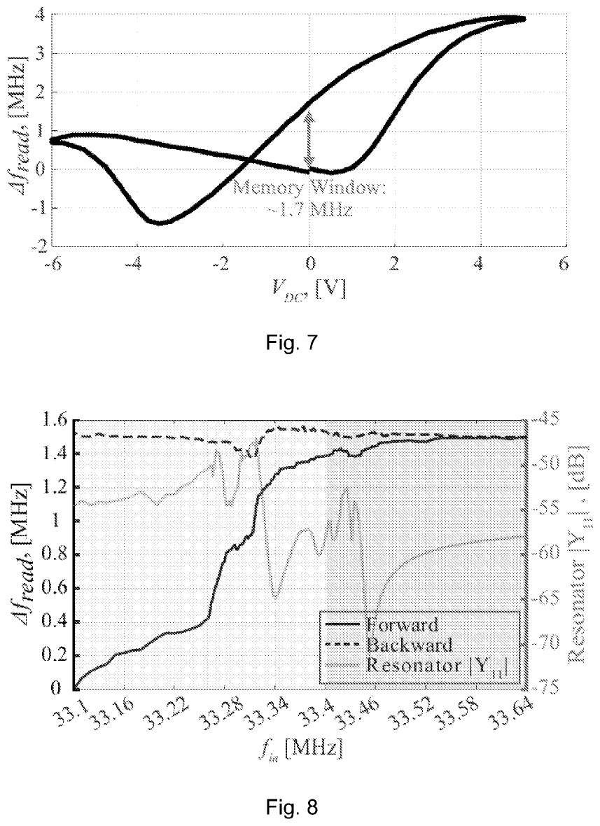

First, the ferroelectric response of the LC tank was measured from the read port under varying biasing voltages. The HZO varactor was initially polarized in its negative polarization state, followed by the application of a positive bias voltage up to 6 V in increments of 0.25 V. Subsequently, the bias voltage was decreased back to 0 V, followed by negative bias voltages up to 5 V. Finally, we brought the applied DC voltage back to 0 V. The admittance of the system from the read port was measured at each voltage step using −20 dBm of RF power. The Δf_{read} around 260 MHz versus bias voltage levels is reported in FIG. 8. Similar to the varactor's response reported in FIGS. 12A-12C, the system exhibited an asymmetric behavior for the positive and negative voltage levels, resulting in a 1.7 MHz wide memory window for the unbiased system.

### Response to RF Signal

The ferroelectric response of the system under RF input signals was assessed. Following a negative polarization of the varactor, the system was subjected to a 10 dBm RF signal with fᵢₙ varying from 33.1 MHz to 33.64 MHz. For each analyzed step, the system was driven with the RF signal for a duration (t_{drive}) of 0.1 s, followed by extraction of the reflection coefficient (S₁₁) relative to the read port using −20 dBm power. This excite-measure cycle was repeated for fᵢₙ varying in both forward and backward directions from 33.1 MHz to 33.64 MHz. The extracted S₁₁ was then used to measure Δf_{read} (FIG. 8, left-axis). The input admittance (Y₁₁) relative to the drive-port (see FIG. 1B) also was recorded for each analyzed frequency step (FIG. 8, right-axis). The Δf_{read} trend shown in FIG. 8 for the forward direction can be evaluated by analyzing the system's behavior in three different frequency intervals. For fᵢₙ varying between 33.1 MHz and 33.25 MHz (see the left shaded area in FIG. 8), the DC voltage developed from the applied RF signal across the varactor due to nonlinearities was relatively low, being only responsible for inducing a partial ferroelectric switch of the HZO film that causes a rather limited increase of Δf_{read}. The second interval for fᵢₙ varied from 33.25 MHz to 33.34 MHz (see the middle shaded area in FIG. 8) and includes fₛ. Therefore, the DC voltage generated across the varactor increases and becomes the maximum when fᵢₙ=fₛ. This leads to an increase of the number of domains experiencing a ferroelectric switching and, consequently, to a significant increase of Δf_{read}. Finally, for fᵢₙ varying between 33.34 MHz and 33.64 MHz (see the right shaded area in FIG. 8), the DC voltage generated drops. Such drop, combined with the significant amount of domains of the HZO film that have already been switched, leads to a Δf_{read} trend resembling that of the first frequency interval. At the end of the third frequency interval, fᵢₙ was shifted back to 33.1 MHz. Since the great majority of the HZO domains had already been switched, no significant change was observed in Δf_{read}, despite subjecting the varactor to the same voltage profile during the backward frequency sweep. This measurement clearly shows how the sensor device experiences a hysteresis behavior in Δf_{read} generated from the only use of input RF signals. While these measurements refer to a varying fᵢₙ value and a constant fₛ value, the device's behavior is analogous if fᵢₙ is constant and fₛ varies. In fact, it is the difference between fᵢₙ and fₛ that ultimately controls the amount of HZO domains that are switched within a certain time interval. In this regard, hysteresis behavior of the device grants the ability to mark and to memorize events that have caused shifts off s. At the end of this test, the total change in Δf_{read} was measured to be around 1.5 MHz. Comparing this value with the available memory window given in FIG. 7 one can conclude that the majority of the available memory window has been utilized.

### Temperature Threshold Sensing

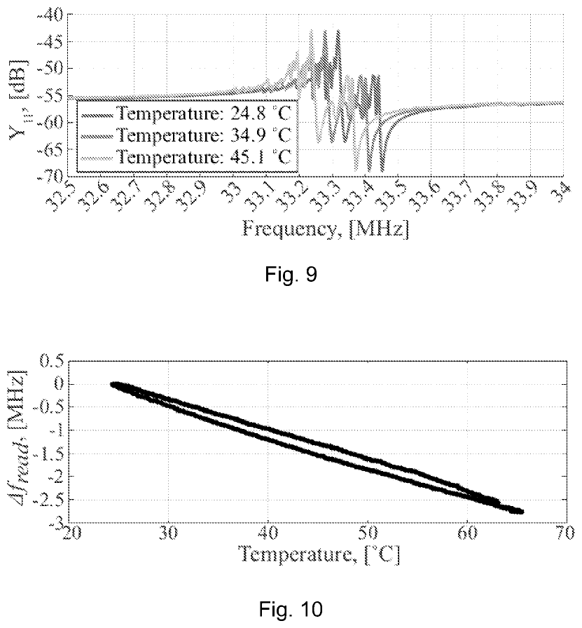

Finally, the implemented sensor device was tested as a temperature threshold sensor. Initially, Y₁₁ of the system at different temperatures was measured from the drive port with an RF power level of −20 dBm, while the read port of the system was terminated via an SMA 50-1 male termination cap. These measurement results are given in FIG. 9, illustrating that fₛ has a TC_{f} of 124 ppm/C. Moreover, corresponding Tₜₕ for a given fᵢₙ, i.e., the tunability of the threshold sensing system, can be extracted from these measurements. The threshold violation occurs when Δf is nullified. As can be seen in FIG. 9, at a temperature of 35° C., fs is 33.279 MHz. Thus, when the threshold sensing system is excited with an fᵢₙ of 33.279 MHz at room temperature, the Δf is nullified and the voltage across the varactor reaches its maximum at approximately 35° C. Consequently, Tₜₕ for an fᵢₙ of 33.279 MHz is approximately 35° C. Similarly, when the resonator is excited with an fᵢₙ of 33.23 MHz, the corresponding threshold temperature will be around 45° C.

The same test setup presented in FIG. 1B was also employed for a threshold detection test of the full sensor device system. A similar excite-measure cycle to that used in the RF signal characterization experiment was also utilized for the temperature threshold sensing experiments, but with a constant fᵢₙ. The system was excited with a 10 dBm RF signal from the drive port with an fᵢₙ of 33.278 MHz for a t_{drive} of 0.1 s. Subsequently, the Δf_{read} was measured from the read port using VNA-II with an RF power of −20 dBm. However, prior to testing the actual system, the temperature-response of the PCB board and the inductor with off-the-shelf components was measured. For that purpose, the HZO varactor and the LiNbO₃ resonator were replaced with two capacitors having similar capacitance values to C_{HZO} and to Cₒ. The PCB was heated to 65° C. and then cooled back to room temperature. The result of this experiment is shown in FIG. 10; it demonstrated a significant change in Δf_{read} due to the temperature coefficients of capacitances and inductances of the components and the PCB. However, the PCB with the off-the-shelf components exhibited no permanent change in Δf_{read} upon cooling back to room temperature.

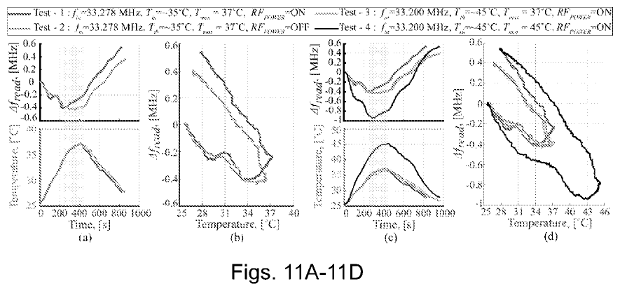

Next, the temperature response of the actual threshold sensing system with HZO varactor and the LiNbO₃ resonator was measured in four different experiments. In each experiment, the same HZO varactor was utilized after it was brought to its negatively polarized state by applying reset pulses. In the first experiment, fᵢₙ was set to 33.278 MHz, which corresponds to a Tₜₕ of 35° C., with an RF power level of 10 dBm. The system was heated-up to 37° C. and then cooled back to room temperature (Test-1). This experiment was then repeated with the RF power of the CW signal turned off (Test-2). The results of these experiments are presented in FIG. 11A and FIG. 11B. FIG. 11A shows the temperature profile and the corresponding change in Δf_{read} in the time domain. As observed, during the initial 250 seconds of heating and the subsequent cooling period starting from 450 seconds until the end, the response of the system is primarily influenced by the temperature response of the PCB and the inductor. However, clear evidence of the ferroelectric switching is visible between these time intervals (highlighted in FIG. 11A). When Tₜₕ is exceeded, Δf_{read} increased in Test-1, whereas in Test-2, where the RF power is turned off, Δf_{read} remained constant. FIG. 11B shows the resulting hysteresis during these experiments. As can be seen, when the CW signal's RF power was turned off, the hysteresis in Δf_{read} Was around 0.4 MHz, attributable to the retention of the HZO varactor [40]. However, when the RF-power was on, and in the event of temperature violation, this hysteresis increased to 0.55 MHz due to ferroelectric switching of the HZO varactor resulting from the violation of the Tₜₕ.

Finally, to demonstrate the tunability of Tₜₕ, fᵢₙ was changed to 33.2 MHz yielding a Tₜₕ Of 45° C. Then, the system was exposed to two different temperature cycles when the RF power was turned on. In Test-3, the system was heated up to 37° C., and in Test-4 the system was heated to 45° C., which violates the new Tₜₕ value. The results of these experiments are superimposed with the results of the initial two experiments and are shown in FIGS. 11C and 11D. FIG. 11C shows the time domain behavior of the Δf_{read} and the temperature profile while, FIG. 13-d shows the hysteresis in Δf_{read} with temperature. Both the time domain (FIG. 11C) and hysteresis (FIG. 11D) plots demonstrate that, for the new Tₜₕ value, the change in Δf_{read} was similar to Test-2, where the RF power was turned off, while the threshold temperature was not exceeded in Test-3. Conversely, in Test-4, where the temperature cycle violated the new Tₜₕ value, the change in Δf_{read} resembled that of Test-1. Both Test-1 and Test-4 showed a similar increasing trend in Δf_{read} during the temperature violation (shaded are in FIG. 11C) and a similar hysteresis in Δf_{read} (−0.55 MHz) in FIG. 11D.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of”or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

### REFERENCES

1. M. A. A. Mamun and M. R. Yuce, “Sensors and systems for wearable environmental monitoring toward iot-enabled applications: A review,” IEEE Sensors Journal, vol. 19, no. 18, pp. 7771-7788, 2019.
2. H. Yang, S. Kumara, S. T. S. Bukkapatnam, and F. Tsung, “The internet of things for smart manufacturing: A review,” IISE Transactions, vol. 51, no. 11, pp. 1190-1216, 2019, doi: 10.1080/24725854.2018.1555383. [Online]. Available: doi.org/10.1080/24725854.2018.1555383
3. S. L. Ullo and G. R. Sinha, “Advances in smart environment monitoring systems using iot and sensors,” 2020.
4. T. Wu, F. Wu, C. Qiu, J. M. Redouté, and M. R. Yuce, “A rigid-flex wearable health monitoring sensor patch for iot-connected healthcare applications,” IEEE Internet of Things Journal, vol. 7, no. 8, pp. 6932-6945, 2020.
5. M. Faris, M. N. Mahmud, M. F. M. Salleh, and A. Alnoor, “Wireless sensor network security: A recent review based on state-of-the-art works,” International Journal of Engineering Business Management, vol. 15, p. 18479790231157220, 2023, doi: 10.1177/18479790231157220. [Online]. Available: doi.org/10.1177/18479790231157220
6. V. Chawla and D. S. Ha, “An overview of passive rfid,” IEEE Communications Magazine, vol. 45,no. 9, pp. 11-17, 2007.
7. R. Bhattacharyya, C. Floerkemeier, and S. Sarma, “Rfid tag antenna based temperature sensing,” in 2010 IEEE International Conference on RFID (IEEE RFID 2010), Conference Proceedings, pp. 8-15.
8. S. Caizzone, C. Occhiuzzi, and G. Marrocco, “Multi-chip rfid antenna integrating shape-memory alloys for detection of thermal thresholds,” IEEE Transactions on Antennas and Propagation, vol. 59, no. 7, pp. 2488-2494, 2011.
9. A. Ramos, A. Lazaro, R. Villarino, and D. Girbau, “Sensing of thermal thresholds using uwb rfid passive tags,” in SENSORS, 2014 IEEE, Conference Proceedings, pp. 1503-1506.
10. Y. Liu, X. Ma, Y. Li, Y. Tie, Y. Zhang, and J. Gao, “Water pipeline leakage detection based on machine learning and wireless sensor networks,”2019.
11. R. Badia-Melis, U. Mccarthy, L. Ruiz-Garcia, J. Garcia-Hierro, and J. I. Robla Villalba, “New trends in cold chain monitoring applications—a review,” Food Control, vol. 86, pp. 170-182, 2018. [Online]. Available: https://www.sciencedirect.com/science/article/pii/S0956713517305558
12. A. Carullo, S. Corbellini, M. Parvis, and A. Vallan, “A wireless sensor network for cold-chain monitoring,” IEEE Transactions on Instrumentation and Measurement, vol. 58, no. 5, pp. 1405-1411, 2009.
13. G. Bruckner, J. Bardong, C. Gruber, and V. Plessky, “A wireless, passive id tag and temperature sensor for a wide range of operation,” Procedia Engineering, vol. 47, pp. 132-135, 2012. [Online]. Available: www.sciencedirect.com/science/article/pii/S1877705812041574
14. T. T. Thai, J. M. Mehdi, F. Chebila, H. Aubert, P. Pons, G. R. DeJean, M. M. Tentzeris, and R. Plana, “Design and development of a novel passive wireless ultrasensitive rf temperature transducer for remote sensing,” IEEE Sensors Journal, vol. 12, no. 9, pp. 2756-2766, 2012.
15. I. Zalbide, E. D. Entremont, A. Jiménez, H. Solar, A. Beriain, and R. Berenguer, “Battery-free wireless sensors for industrial applications based on uhf rfid technology,” in SENSORS, 2014 IEEE, Conference Proceedings, pp. 1499-1502.
[16] X.-G. Tian, H. Liu, L.-Q. Tao, Y. Yang, H. Jiang, and T.-L. Ren, “High-resolution, high-linearity temperature sensor using surface acoustic wave device based on linbo3/sio2/si substrate,” AIP Advances, vol. 6, no. 9, p. 095317, 2016, doi: 10.1063/1.4963797. [Online]. Available: doi. org/10.1063/1.4963797
[17] H. Campanella, M. Narducci, S. Merugu, and N. Singh, “Dual mems resonator structure for temperature sensor applications,” IEEE Transactions on Electron Devices, vol. 64, no. 8, pp. 3368-3376, 2017.
[18] C. Ghouila-Houri, A. Talbi, R. Viard, Q. Gallas, E. Garnier, P. Molton, J. Delva, A. Merlen, and P. Pernod, “Mems high temperature gradient sensor for skin-friction measurements in highly turbulent flows,”in 2019 IEEE SENSORS, Conference Proceedings, pp. 1-4.
[19] A. Jiménez-Sáez, P. Schumacher, K. Häuser, M. Schu\ddot{}ßler, J. R. Binder, and R. Jakoby, “Chipless wireless high temperature sensing based on a multilayer dielectric resonator,” in 2019 IEEE SENSORS, Conference Proceedings, pp. 1-4.
[20] H. M. E. Hussein and C. Cassella, “Giant sensitivity through fully-passive and chip-less parametric temperature sensors,” in 2020 IEEE SENSORS, Conference Proceedings, pp. 1-4.
[21 ] H. M. E. Hussein, M. Rinaldi, M. Onabajo, and C. Cassella, “A chip-less and battery-less subharmonic tag for wireless sensing with parametrically enhanced sensitivity and dynamic range,” Scientific Reports, vol. 11, no. 1, p. 3782, 2021. [Online]. Available: doi. org/10.1038/s41598-021-82894-x
[22] ______, “Capturing and recording cold chain temperature violations through parametric alarm-sensor tags,” Applied Physics Letters, vol. 119, no. 1, p. 014101, 2021, doi: 10.1063/5.0054022. [Online]. Available: doi.org/10.1063/5.0054022
[23] J. Zhao, Y. Xing, J. Han, W. Lin, X. Yun, Y. Sun, X. Zhou, Z. Wang, X. Cao, B. Zhang, and Y. Wang, “The research of dual-mode film bulk acoustic resonator for enhancing temperature sensitivity,” Semiconductor Science and Technology, vol. 36, no. 2, p. 025018, 2021. [Online]. Available: dx. doi.org/10.1088/1361-6641/abd15c
[≥] H. W. Park, J.-G. Lee, and C. S. Hwang, “Review of ferroelectric field-effect transistors for three-dimensional storage applications,” Nano Select, vol. 2, no. 6, pp. 1187-1207, 2021, doi.org/10.1002/nano.202000281. [Online]. Available: https: //doi.org/10.1002/nano.202000281
[25] J. Y. Kim, M.-J. Choi, and H. W. Jang, “Ferroelectric field effect transistors: Progress and perspective,”APL Materials, vol. 9, no. 2, p. 021102, 2021, doi: 10.1063/5.0035515. [Online]. Available: doi.org/10.1063/5.0035515
[26] A. I. Khan, A. Keshavarzi, and S. Datta, “The future of ferroelectric field-effect transistor technology,” Nature Electronics, vol. 3, no. 10, pp. 588-597, 2022. [Online]. Available: doi.org/10.1038/s41928-020-00492-7
[27] R. A. Mena and A. Kozitsky, “Rf430frl152h novel ferroelectric ram memory (fram) nfc embedded tag based sensors,”Texas Instruments, 2012.
[28] T. Tharpe, F. Hakim, and R. Tabrizian, “In-plane bulk acoustic resonators using 50 nm-thick nano-laminated ferroelectric hf0.5zr0.5o2,” in 2021 21st International Conference on Solid-State Sensors, Actuators and Microsystems (Transducers), Conference Proceedings, pp. 313-316.
[29] T. Tharpe, X.-Q. Zheng, P. X. L. Feng, and R. Tabrizian, “Resolving mechanical properties and morphology evolution of free-standing ferro-electric hf_{0.5} zr 0.5 o 2,” Advanced Engineering Materials, 2021.
[30] S. S. Cheema, N. Shanker, L.-C. Wang, C.-H. Hsu, S.-L. Hsu, Y.-H. Liao, M. San Jose, J. Gomez, W. Chakraborty, W. Li, J.-H. Bae, S. K. Volkman, D. Kwon, Y. Rho, G. Pinelli, R. Rastogi, D. Pipitone, C. Stull, M. Cook, B. Tyrrell, V. A. Stoica, Z. Zhang, J. W. Freeland, C. J. Tassone, A. Mehta, G. Saheli, D. Thompson, D. I. Suh, W.-T. Koo, K.-J. Nam, D. J. Jung, W.-B. Song, C.-H. Lin, S. Nam, J. Heo, N. Parihar, C. P. Grigoropoulos, P. Shafer, P. Fay, R. Ramesh, S. Mahapatra, J. Ciston, S. Datta, M. Mohamed, C. Hu, and S. Salahuddin, “Ultrathin ferroic hfo2-zro2 superlattice gate stack for advanced transistors,” Nature, vol. 604, no. 7904, pp. 65-71, 2022. [Online]. Available: doi.org/10.1038/s41586-022-04425-6
31. V. Gund, B. Davaji, S. Jadhav, H. Lee, D. Jena, H. G. Xing, and A. Lal, “Multi-level analog programmable graphene resistive memory with fractional channel ferroelectric switching in hafnium zirconium oxide,” in 2022 Joint Conference of the European Frequency and Time Forum and IEEE International Frequency Control Symposium (EFTF/IFCS), Conference Proceedings, pp. 1-4.
32. S. Jadhav, V. Gund, B. Davaji, D. Jena, H. Xing, and A. Lal, “HZO-based ferronems mac for in-memory computing,” Applied Physics Letters, vol. 121, no. 19, p. 193503, 2022, (Grace) doi: 10.1063/5.0120629. [Online]. Available: doi.org/10.1063/5.0120629
33. S.-H. Tsai, Z. Fang, X. Wang, U. Chand, C.-K. Chen, S. Hooda, M. Sivan, J. Pan, E. Zamburg, and A. V.-Y. Thean, “Stress-memorized hzo for high-performance ferroelectric field-effect memtransistor,” ACS Applied Electronic Materials, 2022, doi: 10.1021/acsaelm.1c01321. [Online]. Available: doi.org/10.1021/acsaelm.1c01321
34. X.-Q. Zheng, T. Tharpe, S. M. Enamul Hoque Yousuf, N. G. Rudawski, P. X. L. Feng, and R. Tabrizian, “High quality factors in superlattice ferroelectric hf0.5zr0.5o2 nanoelectromechanical resonators,”ACS Applied Materials & Interfaces, vol. 14, no. 32, pp. 36 807-36 814, 2022, doi: 10.1021/acsami.2c08414. [Online]. Available: doi.org/10.1021/acsami.2c08414
35. S. Jadhav, V. Gund, and A. Lal, “Programmable ferroelectric hzo nems mechanical multiplier for in-memory computing,” in 2023 IEEE 36th International Conference on Micro Electro Mechanical Systems (MEMS), Conference Proceedings, pp. 519-521.
36. A. Kashir, M. Ghiasabadi Farahani, S. Kamba, M. Yadav, and H. Hwang, “Hf1-xzrxo2/zro2 nanolaminate thin films as a high-k dielectric,” ACS Applied Electronic Materials, vol. 3, no. 12, pp. 5632-5640, 2021, doi: 10.1021/acsaelm.1c01105. [Online]. Available: doi.org/10.1021/acsaelm.1c01105
37. R. T. Smith and F. S. Welsh, “Temperature dependence of the elastic, piezoelectric, and dielectric constants of lithium tantalate and lithium niobate,” Journal of Applied Physics, vol. 42, no. 6, pp. 2219-2230, 2003. [Online]. Available: https: //doi.org/10.1063/1.1660528
38. L. Colombo, M. E. G. Klemash, T. M. Kiebala, S. S. Bedair, G. Piazza, and M. Rinaldi, “Vhf and uhf lithium niobate mems resonators exceeding 30 db of passive gain,” IEEE Electron Device Letters, vol. 42, no. 12, pp. 1853-1856, 2021.
39. Y.-C. Luo, J. Hur, P. Wang, A. I. Khan, and S. Yu, “Nonvolatile, small-signal capacitance in ferroelectric capacitors,” Applied Physics Letters, vol. 117, no. 7, 2020. [Online]. Available: doi.org/10.1063/5.0018937
40. A. Chouprik, E. Kondratyuk, V. Mikheev, Y. Matveyev, M. Spiridonov, A. Chernikova, M. G. Kozodaev, A. M. Markeev, A. Zenkevich, and D. Negrov, “Origin of the retention loss in ferroelectric hf0.5zr0.5o2-based memory devices,” Acta Materialia, vol. 204, p. 116515, 2021. [Online]. Available: www.sciencedirect.com/science/article/pii/ S1359645420309435

### 41. G. Bruckner, J. Bardong, C. Gruber, and V. Plessky, EUROSENSOR, 2012 [Procedia Eng. 47,15132-135 (2012)].

42. Hussein M. E. Hussein, Matteo Rinaldi, Marvin Onabajo, and Cristian Cassella, Appl. Phys. Lett. 119, 014101 (2021)

What is claimed is:

1. A parameter threshold sensor device comprising, in series, a drive port, a resonator, a ferroelectric varactor, an inductor, and a read port;
wherein the inductor forms a series LC resonant circuit with the varactor;
wherein the LC resonant circuit is in series with the resonator;
wherein the inductor is connected to the read port and the resonator is connected to the drive port; and
wherein, with application of a continuous wave signal at the drive port at a frequency detuned from a resonance frequency of the resonator, detection of said parameter by the device in an amount above a preset threshold causes a non-volatile change in capacitance of the varactor and a shift in resonance frequency detectable at the read port.

2. The sensor device of claim 1, wherein the resonator is a surface acoustic wave resonator.

3. The sensor device of claim 2, wherein the surface acoustic wave resonator comprises a piezoelectric material selected from the group consisting of LiNbO₃, AlN, and AlScN.

4. The sensor device of claim 1, wherein the ferroelectric varactor comprises a ferroelectric material selected from the group consisting of hafnium zirconium oxide (Hf_{0.5}Zr_{0.5}O₂), scandium-doped aluminum nitride (AlScN), lead zirconium titanate (PZT), barium titanate (BiTiO₃), or barium strontium titanate (BST).

5. The sensor device of claim 1, further comprising one or more additional serially linked resonator-varactor pairs, wherein each serially linked resonator-varactor pair is sensitive to detecting a threshold of a different parameter or a different threshold of a common parameter.

6. The sensor device of any of the preceding claims, wherein the preset threshold is determined by the resonance frequency of the resonator.

7. The sensor device of any of the preceding claims, wherein the capacitance of the varactor is altered by a change in said parameter.

8. The sensor device of any of the preceding claims, wherein said parameter is temperature or pressure.

9. The sensor device of any of the preceding claims, wherein said parameter is the presence, absence, or amount of a biological or chemical agent.

10. The sensor device of claim 9, wherein the resonance frequency detectable at the read port is altered by binding of the biological or chemical agent to a receptor for the biological or chemical agent, and wherein the receptor is bound to the varactor or to a vibrating element of the resonator.

11. The sensor device of any of the previous claims, wherein the device does not comprise a battery.

12. The sensor device of any of the previous claims, wherein the device does not comprise a semiconductor memory.

13. The sensor device of any of claims 1-10, wherein the device comprises a battery and a semiconductor memory.

14. A parameter threshold sensor system comprising:
(i) the sensor device of any of the preceding claims;
(ii) a wireless receiver connected to the drive port of the sensor device, wherein the receiver is configured for providing a source signal at the drive port; and
(iii) a wireless transceiver connected to the read port of the sensor device, the receiver configured for receiving a frequency sweep signal from a remote reader device at the read port and transmitting the resonance frequency at the read port of the sensor device to a remote reader device.

15. The system of claim 14, further comprising a separately housed readout transceiver for use as the remote reader device.

16. A method of detecting a parameter threshold variation, the method comprising the steps of:
(a) placing the parameter threshold sensor device of any of claims 1-13 on an article or in an environment;
(b) applying a continuous wave signal at the drive port of the device, wherein the signal has a frequency detuned from the resonance frequency of the resonator of the device;
(c) applying a sweep of frequencies at the read port of the sensor device using a remote reader device and receiving an output signal across the sweep of frequencies using the remote reader device, thereby determining a readout resonance frequency at the read port of the device; and
(d) comparing the determined readout resonance frequency to an expected readout resonance frequency for a sub-threshold range of said parameter, thereby determining whether a threshold deviation of said parameter has occurred.

17. The method of claim 16, wherein step (d) comprises comparing the output signal at two or more selected wavelengths to expected values of an output signal at said two or more selected wavelengths characteristic of a sub-threshold range of said parameter.

18. The method of claim 16, wherein the parameter is temperature, pressure, or the presence, absence, or amount of a biological or chemical agent.
